(19) United States
(12) Patent Application Publication
(10) Pub. No.: US 2002/0077873 A1
(43) Pub. Date: Jun. 20, 2002

(54) People business network

(76) Inventor: Russell R. Clarke, Somerville, NJ (US)

Correspondence Address: DICKSTEIN SHAPIRO MORIN & OSHINSKY LLP, 2101 L STREET NW, WASHINGTON, DC, 20037-1526, US

(21) Appl. No.: 09/738,327

(22) Filed: Dec. 18, 2000

(51) Int. Cl. G06F 17/60

(52) U.S. Cl. 705/7

(57) ABSTRACT

A system and method for a business computer network implemented on a large scale is disclosed. This business computer network will be a people business network meaning that it will enable employees of various companies to access their personal information in one secure environment yet yielding high speed return of data at minimal costs on the side of the employers.

### BACKGROUND OF THE INVENTION

I. Field of the Invention

The present invention relates generally to large scale business computer networks. More specifically, the invention relates to a business computer network used for maintaining and disseminating employee information including employee benefit information, employment status, and employee compensation information.

II. Description of the Related Art

Currently, most major corporations are trying to maintain employee specific related information on a variety of computer resources that have existed for many years. As illustrated in FIG. 1, this requires a company to link legacy systems 110, 112 to current distributed network architecture systems 108, 104, 102 to enable management and employees access to such information. However, by implementing such legacy systems 110, 112 into a modern network architecture, many networks experience extended lag time, as well as network congestion. In addition, since various pieces of data are residing on different legacy systems 110, 112, the integration of data in one form or in one application cannot be found. Many have tried re-architecture techniques to take data residing on legacy systems 110, 112 and bringing them over to current relational databases 106 in order to improve efficiency. However, the cost associated with rearchitecture is often so high that the course of re-architecture is not chosen. Thus, there exists a need to take employee specific information which includes employee benefit information, employee job status information, employee salary information, etc. and implement all such data in one system which would be an easily accessible high speed network system and that would provide all pertinent data to both employees and managers in an easily obtainable form.

### SUMMARY OF THE INVENTION

The present invention relates to a system and method for a business computer network implemented on a large scale. This business computer network will be a people business network meaning that it will enable employees of various companies to access their personal information in a secure environment yet yielding high speed return of data at minimal costs on the side of the employer. The system comprises a secure global people business network where a company will simply upload all of its current data into relational databases residing at the people business network which then in turn is accessed directly by the end user (employees, managers, etc.). Such a model, do to its global nature, will enable employees, as well as families and spouses, retirees, third party administrators, human resource professionals, health care vendors, financial security vendors, etc. to also access such a system in order to either (1) update data or (2) run reports containing, for example, demographic data, etc. For example, if a company has 145,000 employees, one could assume that families and spouses, who would also be interested in such benefits due to family coverage, would then be in the pool comprising another 450,000 people. Retirees for such a company over the course of several years at that point in time may be 140,000 people. There may be third party administrators dealing with different funds, i.e., mutual funds and other funds that the pension plans revolve around. There may be 50,000 such people who need to monitor accounts or update information to the 145,000 employees, 450,000 families and spouses or 140,000 retirees. Lastly, human resources, health care vendors, financial security vendors may wish to post information to employees regarding changes in coverage, amount of money available in ones benefits a la carte package of resources, or other programs that may become available. Financial security vendors may wish to suggest post changes to ones mutual fund or some type of 401K account. Such a network could clearly exceed 1,000,000 users. Based upon current technology, a network of this type is not supported by the internal networks which have been patched together with legacy system 110, 112 and current distributed architecture networks. However, the present invention of a people business network would allow all of these users access to this global secure network to gain access to this information, as well as update information.

### BRIEF DESCRIPTION OF THE DRAWINGS

The foregoing and other advantages and features of the invention will become more apparent from the detailed description of preferred embodiments of the invention given below with reference to the accompanying drawings in which:

FIG. 1 is an illustration of a current system used to maintain employee specific information;

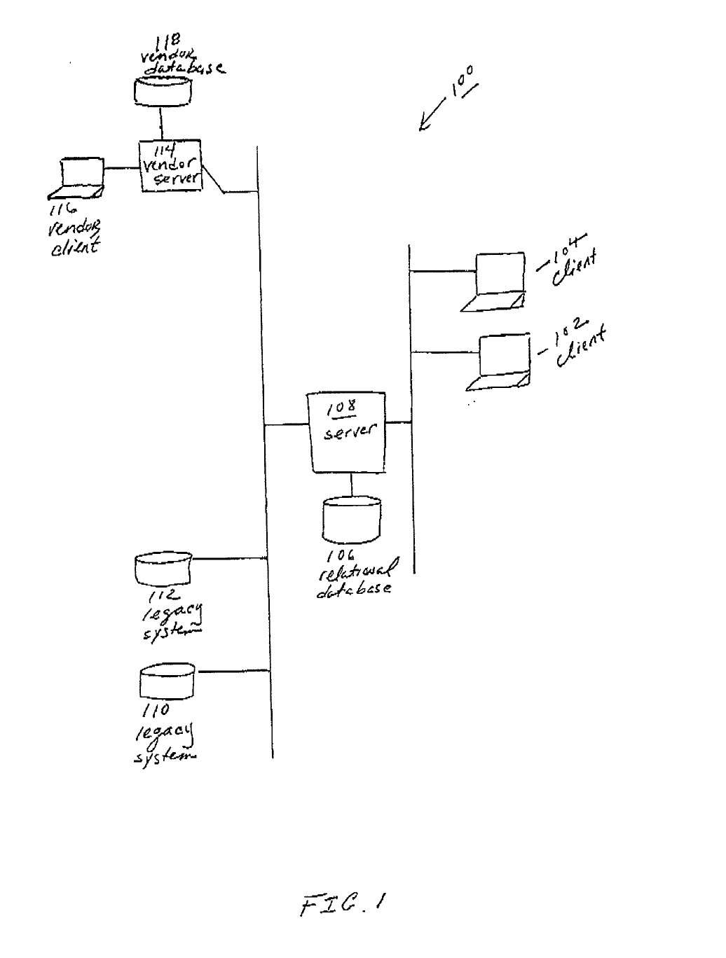

FIG. 2 is a chart illustrating the scalability of a people business network based upon a model of 145,000 employees;

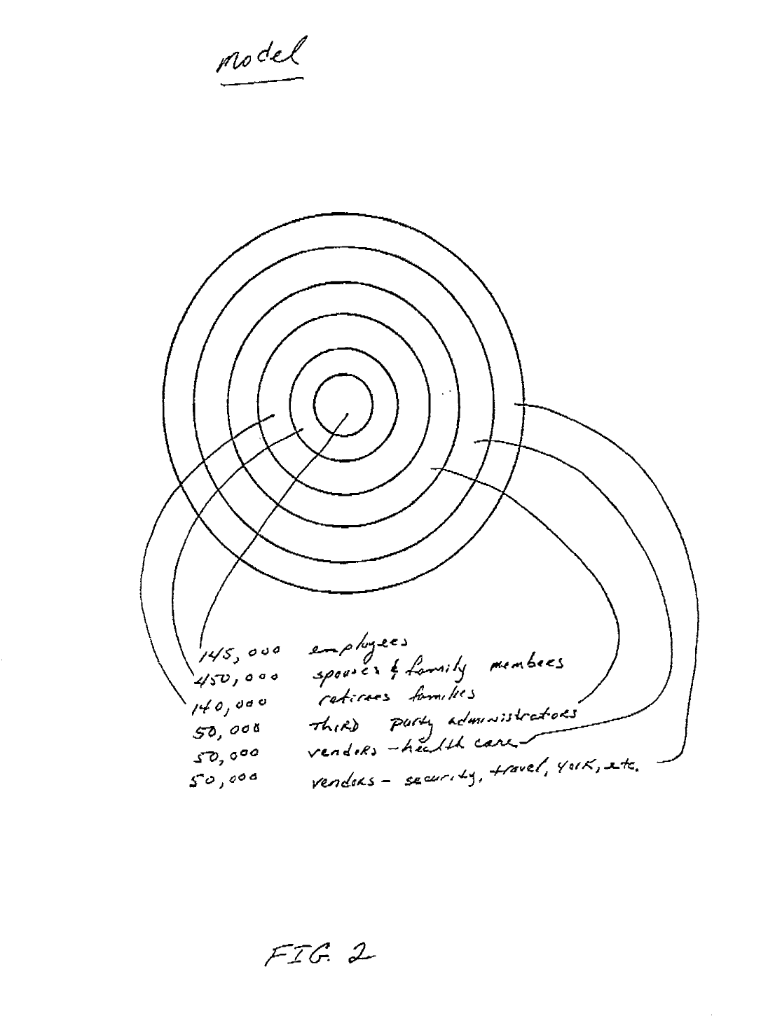

FIG. 3 is an illustration of the network architecture of a preferred embodiment of the present invention;

FIG. 4 is an illustration of the login template for an individual accessing the people business network to view personal information;

FIG. 5 is an illustration of the login template for an individual accessing the people business network as a manager to view personal information of others;

FIG. 6 is an illustration of a personal profile of an employee's personal data in accordance with the preferred embodiment of this invention;

FIG. 7 is an illustration of a personal profile of an employee's current job data in accordance with a preferred embodiment of this invention;

FIG. 8 is an illustration of a personal profile of an employee's reporting relationship in accordance with a preferred embodiment of this invention;

FIG. 9 is an illustration of a personal profile of an employee's W4 information in accordance with the preferred embodiment of this invention;

FIG. 10 is an illustration of a personal profile of an employee's paycheck details in accordance with the preferred embodiment of this invention;

FIG. 11 is an illustration of a personal profile of an employee's previous work experience in accordance with the preferred embodiment of this invention;

FIG. 12 is an illustration of a personal profile of an employee's compensation history in accordance with the preferred embodiment of this invention;

FIG. 13 is an illustration of a personal profile of an employee's formal education and degrees in accordance with a preferred embodiment of this invention;

FIG. 14 is an illustration of a personal profile of an employee's skills and competencies in accordance with a preferred embodiment of this invention; and

FIG. 15 is an illustration of a personal profile of an employee's emergency information and contacts in accordance with a preferred embodiment of this invention.

### DETAILED DESCRIPTION OF THE PREFERRED EMBODIMENTS

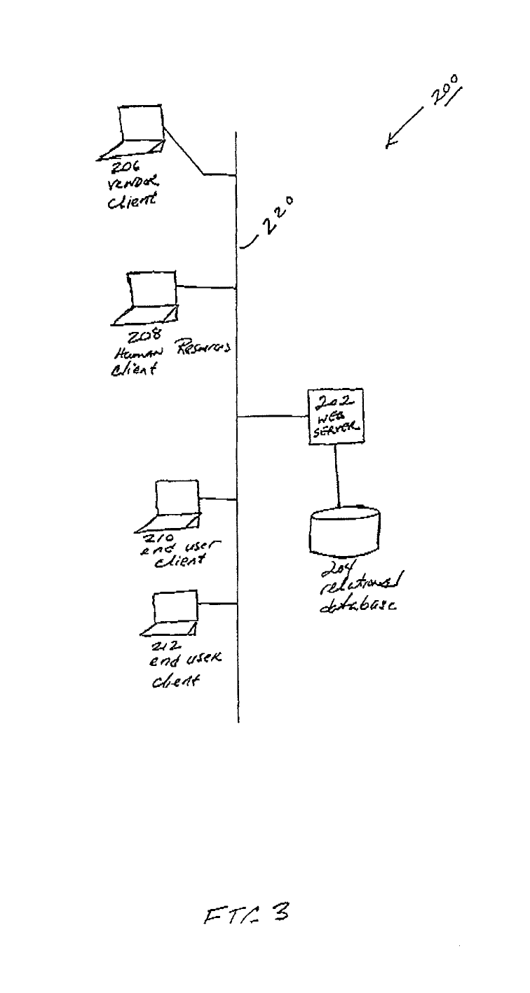

Referring now to the drawings, where like reference numerals designate like elements, there is shown in FIG. 3 a system 200 for a people business network for a people business network. System 200 comprises a web server 202 and relational database 204. The web server is connected to network backbone 220 to communicate with end user clients 210, 212 and human resources client 208. In addition, vendor client(s) 206 are connect to the network backbone 220 to access relational database 204. In operation, an employee may access all pertinent personal employee information through end user clients 210, 212. Manager and human resource (HR) professionals may access information on a plurality of employees through human resource client 208. Vendor client 206 may access information pertaining to vendor specific data, i.e., current return on a particular mutual fund. In actually, the different clients are differentiated only by a difference in login name and password to web server 202. All client may access, view, modify, or change data which they have privileges to view, modify or change.

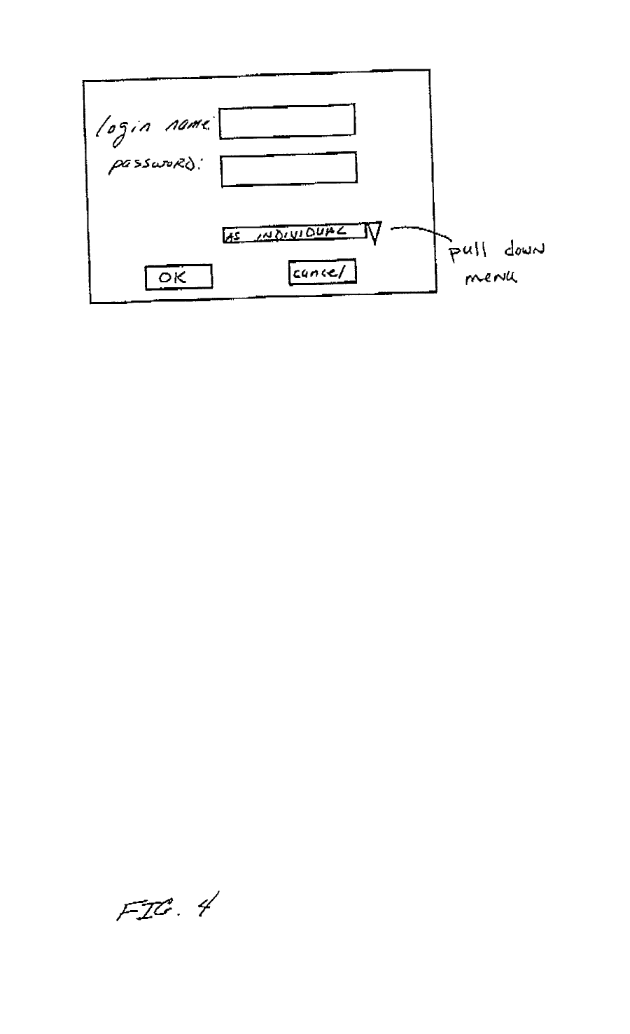

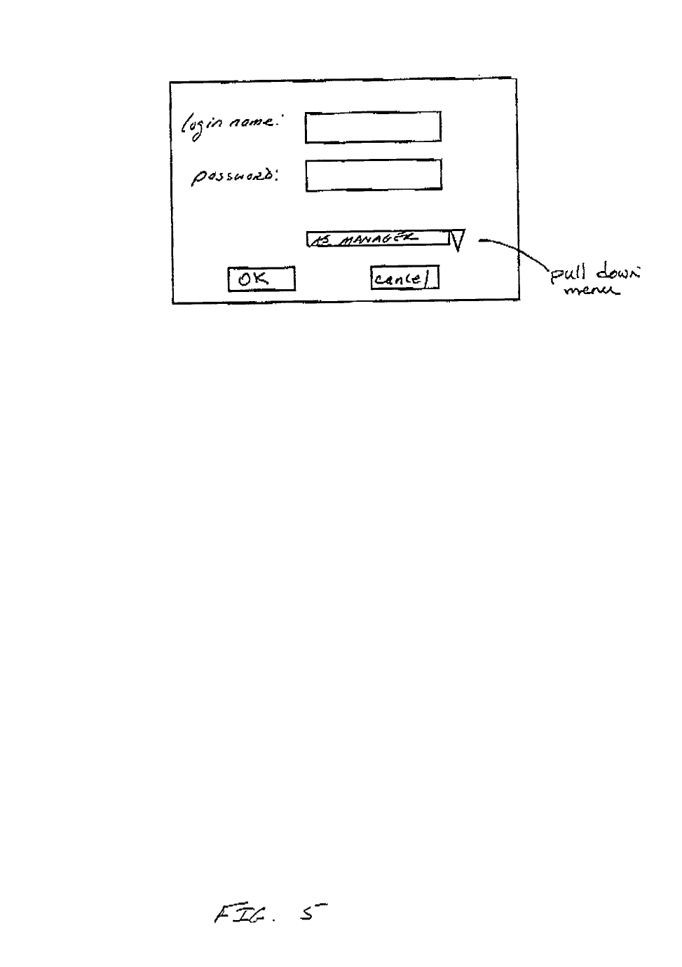

To login to the system 200, a user must login as an individual (employee), manager, human resources personnel, or vendor. Example of login templates are shown in FIGS. 4 and 5.

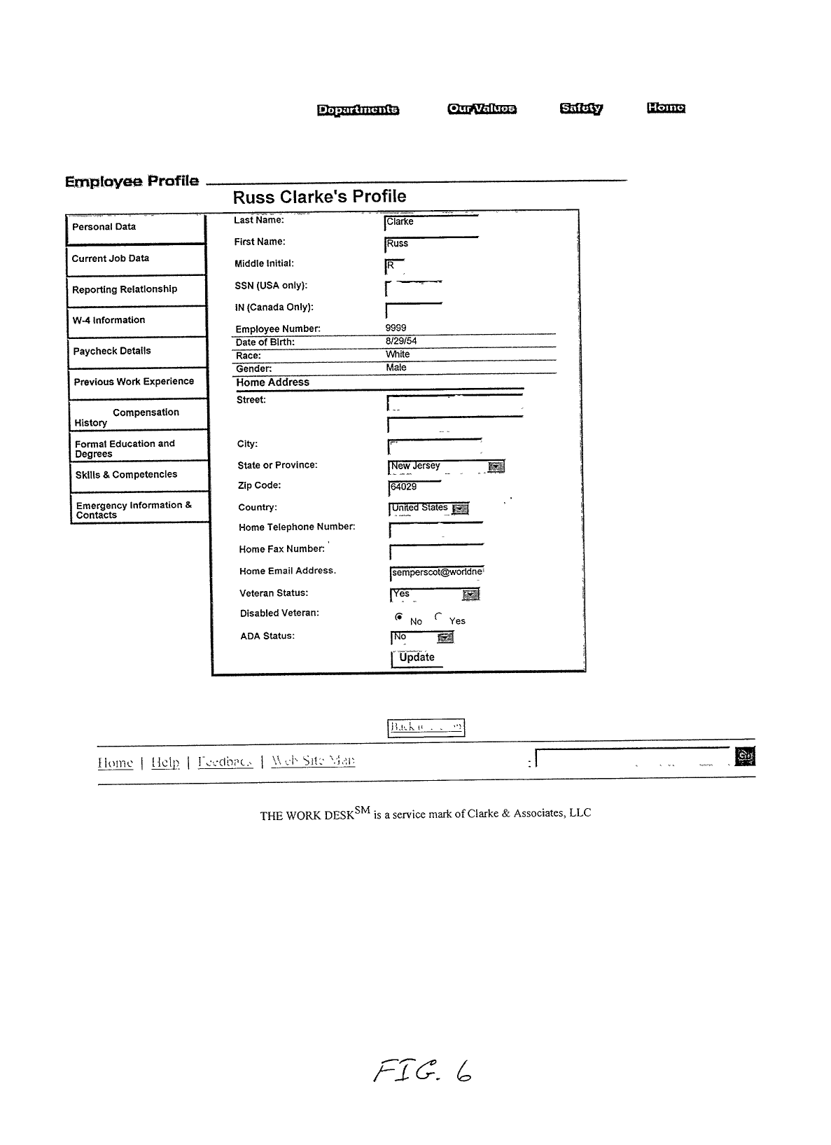

FIG. 6 shows an employee profile of personal data. This is a link to the database for access to records of an employee's personal data including last name, first name, middle name, social security number, address and birth information, etc. A user would use the interface depicted in FIG. 6 to either modify, update or view an employee's personal data.

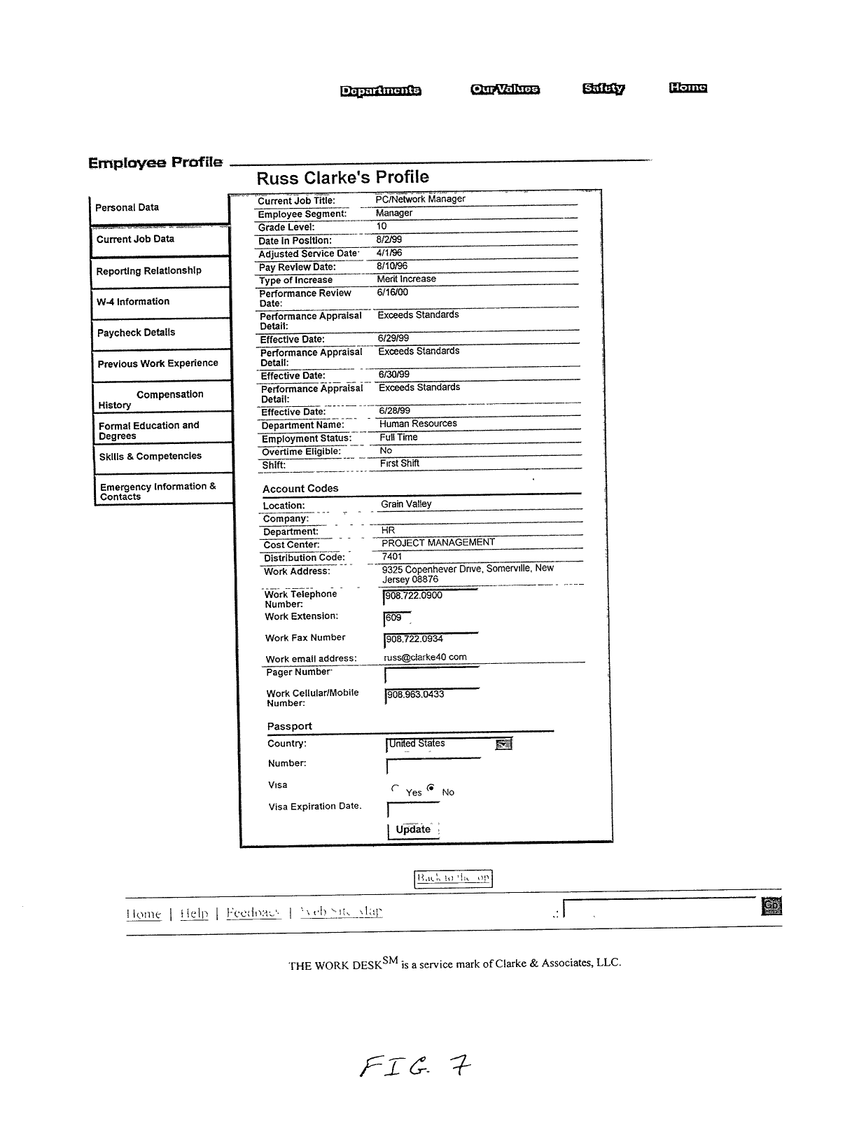

FIG. 7 illustrates an employee's profile with respect to their current job data. FIG. 7 shows information including job title, particular grade, the position and employee health between what dates, what type of pay increases they received, what type of performance appraisals they received, as well as the current job site location and other work related information. This interface, similar to FIG. 6, would be used to view, update, modify, or change an employee's current job information.

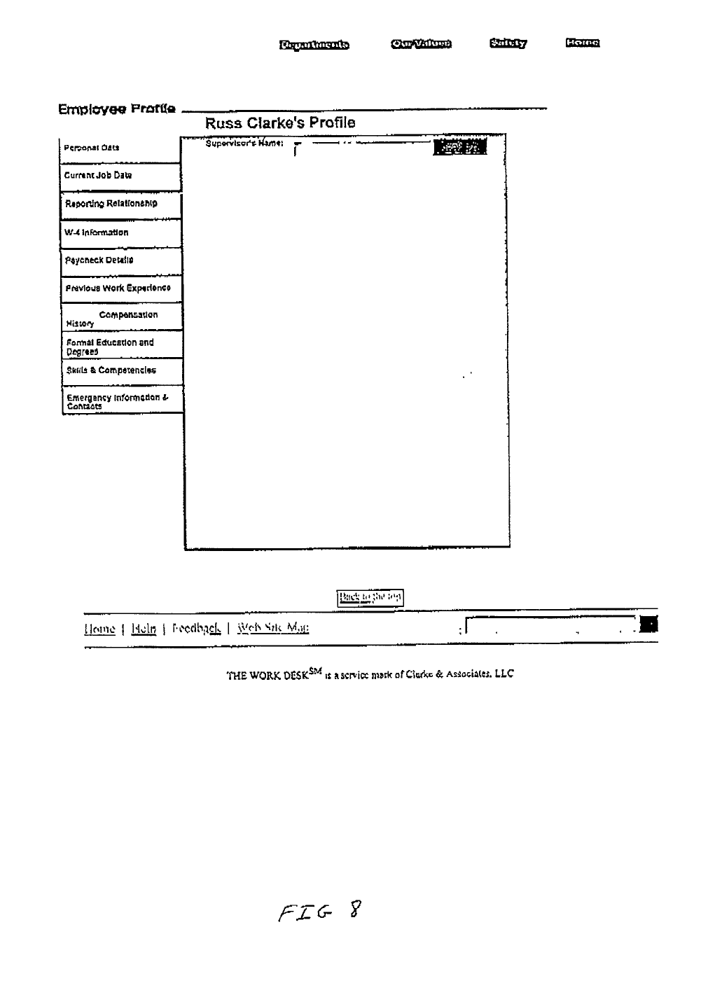

FIG. 8 illustrates an employee's reporting relationship. This can consist of one supervisor's name to which the employee reports to. This may also consist of a chain in command or multiple supervisors to which that employee reports to, as well as those who report to an employee.

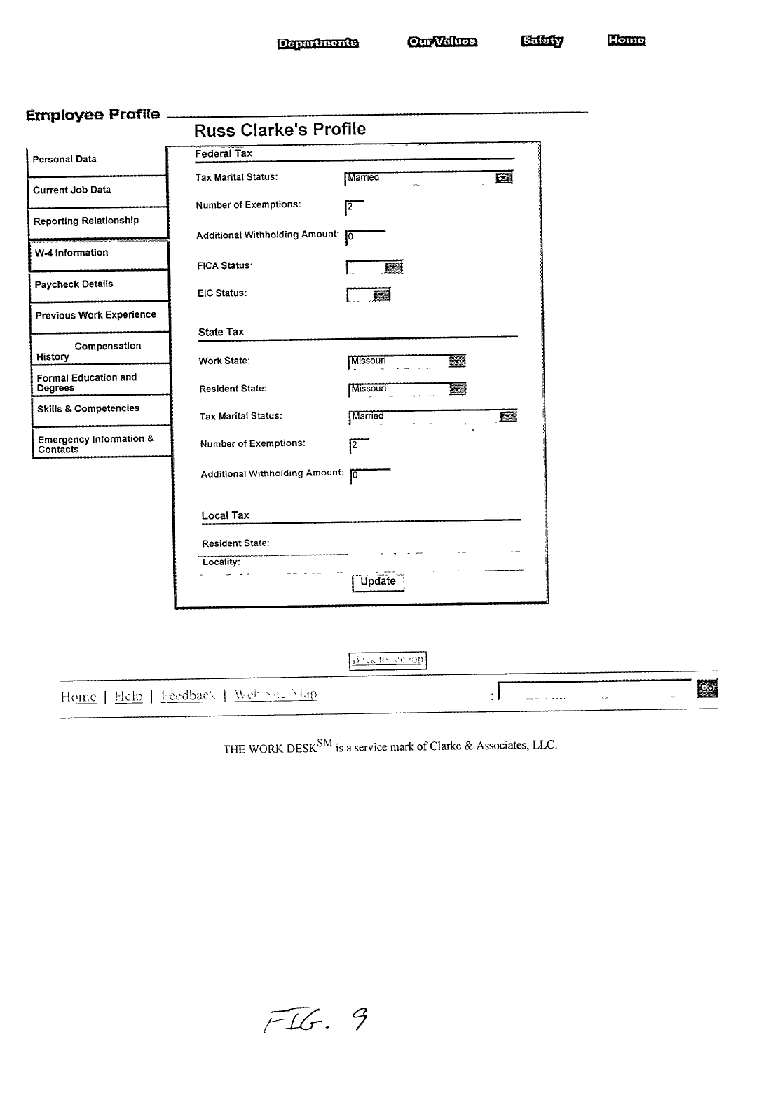

FIG. 9 illustrates an employee profile for W4 information. This can be used by an employee to currently track the number of exemptions for federal, state and local tax purposes, as well as provide an employee with an avenue to change exemptions if need be. This information is also used by the accounting department of various companies to make sure that the correct amounts are being withheld.

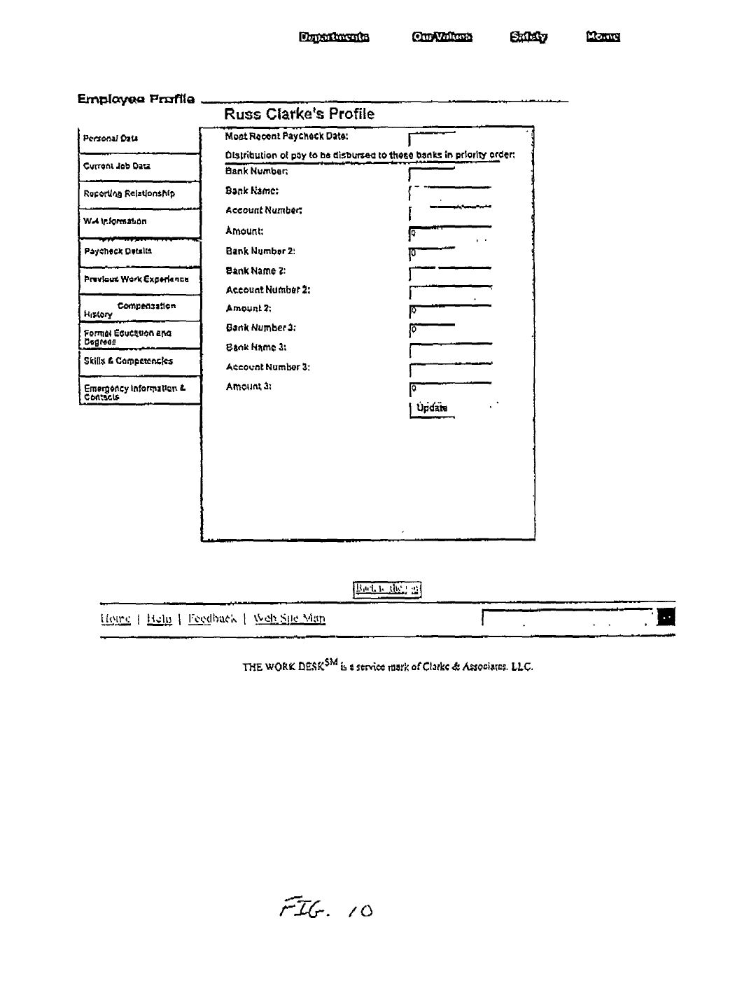

FIG. 10 shows an employee's profile with respect to paycheck details. An employee could see how much each paycheck was, which bank it was directly deposited into, and other bonus information could be found through this template. This would be the place also where the employee could track his or her pay as a manager could also perhaps indicate what one's bonus will be or reflect a raise.

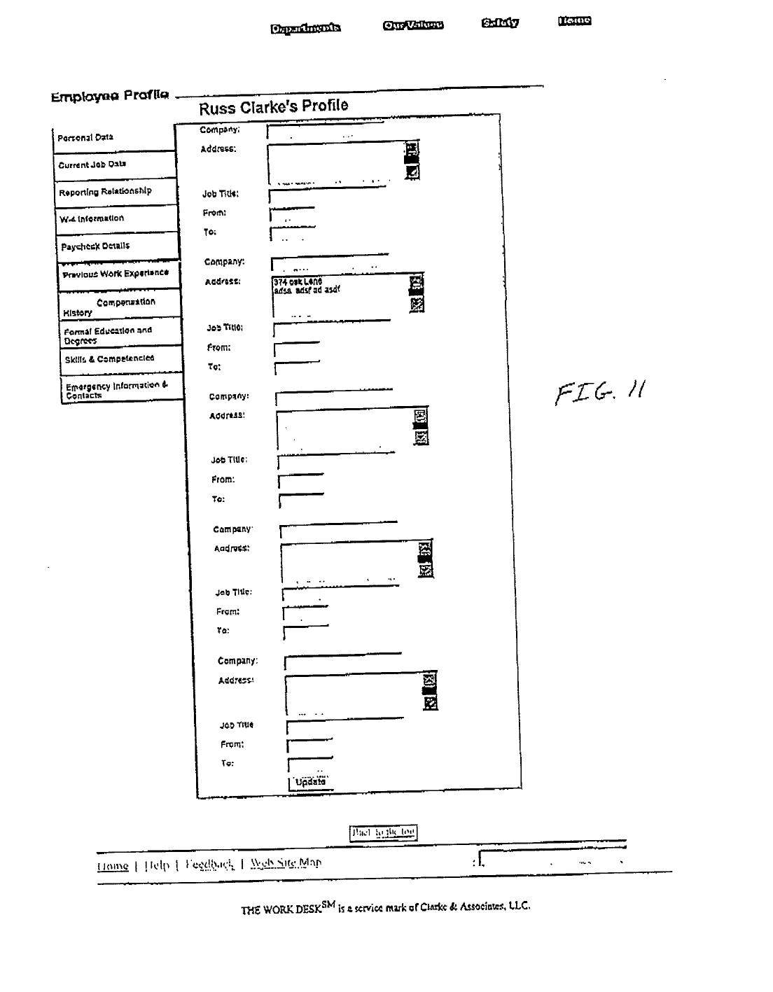

FIG. 11 shows previous work history for an employee. Employees can maintain an ongoing history of his or her work experience. This is often used by employers in terms of marketing the type of employees that they have working on particular tasks in terms of their work experience. This would be a place where an employee could update such information and where it can statically reside for the employee to check, modify or change, as well as for others to look at in terms of mobility or movement within a company for various work tasks.

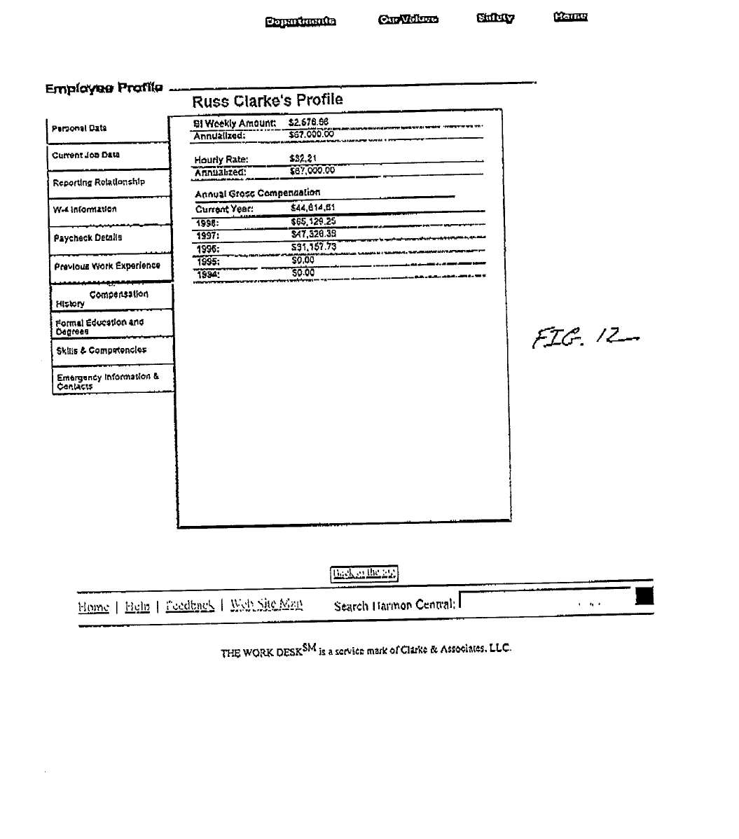

FIG. 12 shows compensation history for an employee's profile. This would basically be a standard template where an employee could track their income gains or losses over the course of a year.

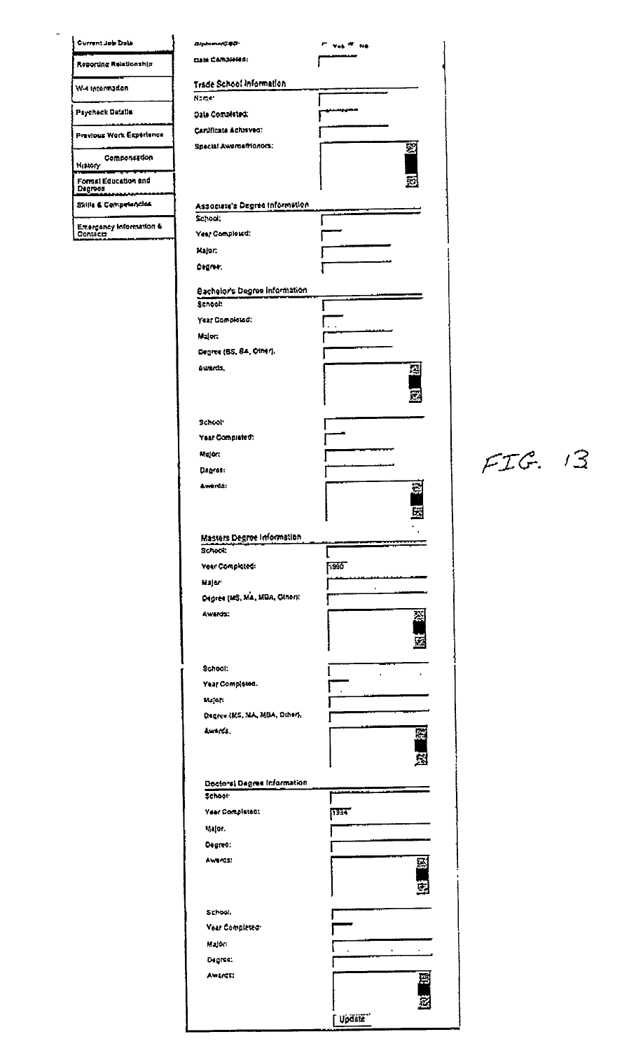

FIG. 13 relates to the formal education degrees. This is where an employee may update, modify or change his or her education and degree information. If an employee were to acquire a new degree an employee could update that at this particular point. This can also be used by other aspects of a corporation in identifying those who would be good for other positions in terms of mobility as well as statistically representing the number of people with degrees in various areas.

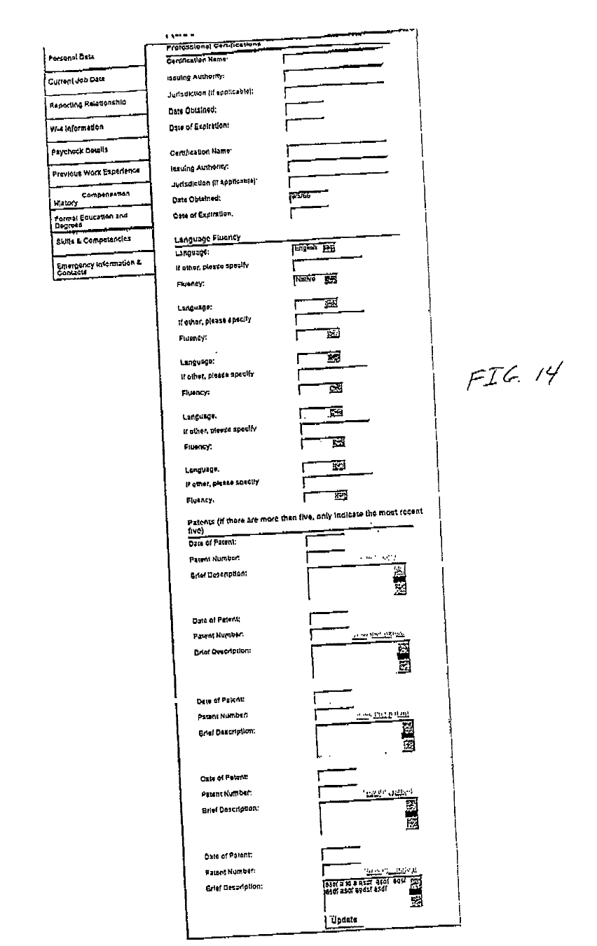

FIG. 14 shows skills and competencies. This employee profile allows one to continually either check, update or modify their skill and competency level as these things change over time. For example, one might acquire the understanding of a new language at which point one could update the database through FIG. 14 to reflect that they are proficient in French, for example. One could also indicate here if an employee is an inventor or if that employee has obtained any patents. Employees can also put in their professional certificates such as a professional engineering license, a license to practice physical therapy, or a license to practice law.

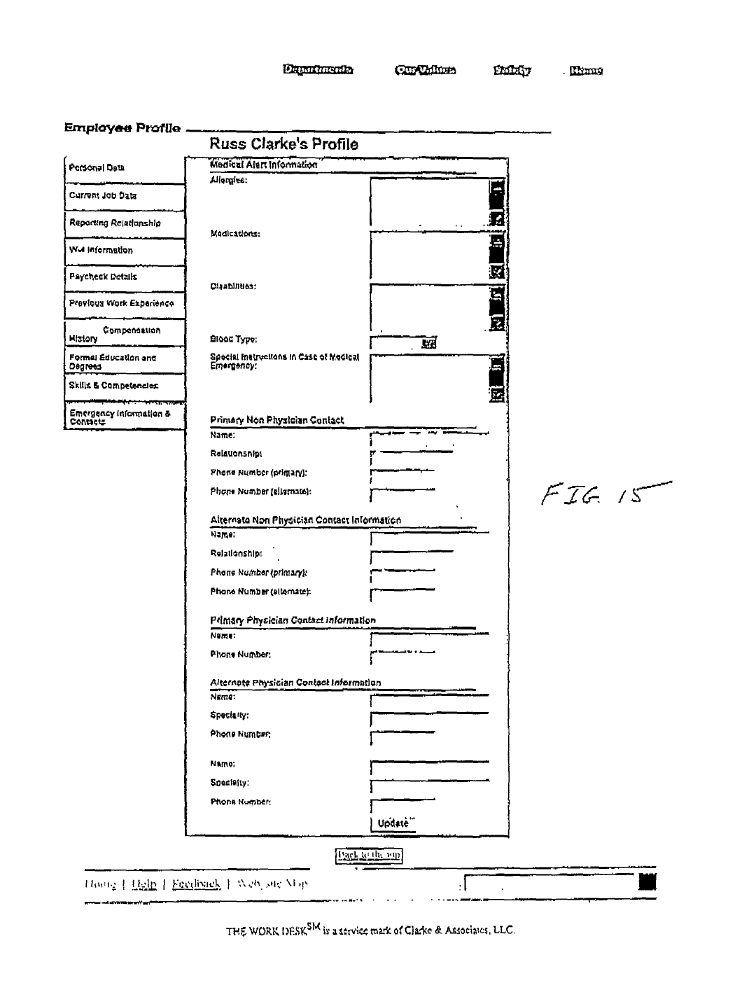

FIG. 15 displays an employee's emergency information and contacts. This information is typically held in hard copy by most corporations, however, this allows an employee to change this information themselves. In addition, upon an employee striking ill, this template allows anyone in the corporation to be able to find out who to contact, whether it be a doctor or spouse or both in order to get that employee the proper attention.

All of the above templates are use to view, modify or change information in relational database 204 for all users. It should also be noted that system 200 is capable of handling data, voice, video, audio, etc.

In the preferred embodiment, system 200 does implement a firewall such that any user on the system that has gained access authentication to the system after that of FIG. 4 or 5 will be operating on a secure encrypted l, whereas others sitting on the global network would not be able to access or intercept such information.

In addition, a user will be able to personalize their desktop for their employee profile. For example, a user may constantly want to look at their current salary versus last year as well as their W4 information as tracked over time. This functionality is available in the people business network. A manager may want to track performance levels in graph form on a particular employee or set of employees in his or her group. This functionality is also available in the people business network.

Since the people business network will not physically reside within one employer, a finance or securities vendor will be able to update one database for a plurality of employers which would bring costs down dramatically and also increase the speed, as the people business network resides on a high speed global network. In addition, in terms of overall cost savings, instead of spending the standard $1000.00 (estimate) a year to maintain all these records on an employee, the people business network could reduce such costs by 3 to 5 fold and also provide free internet access to the employees who are part of this network and keep costs down over the legacy system hodgepodge model. Lastly, since a user's internet shopping can be monitored by such a system, “advertise profiling” is an available option.

It is to be understood that the above description is not intended to be restrictive. There are many variations to the above described system and method that will be readily apparent to those having ordinary skill in the art. For example, virtually any piece of data maintained by a human resources group of a company could reside on the people business network to enable employees, managers and other HR professionals access to such information. In addition, as the people business network is designed to work for one or more employers, if an employee switches from one company to another, where both companies are part of the people business network, a simple change in employer profile would be all that would be needed to reflect the change in that employee's employment which would be a de minus cost.

Accordingly, the present invention is not to be considered as limited by the specifics of the particular structures and method which have been described and illustrated, but is only limited by the scope of the appended claims.

What is claimed as new and desired to be protected by Letters Patent of the United States is:

1. A global business computer network for managing employee data, said network comprising:
a plurality of databases, said databases storing employee specific information for a plurality of employees employed at a plurality of companies; and
at least one web server, said at least one web server communicating with said plurality of databases over a network backbone, said at least one web server providing said employee specific information to a plurality of clients.

2. The network of claim 1, where said plurality of clients comprise end user employee clients, said end user employee clients enabling employees to view and/or modify employee specific information.

3. The network of claim 1, where said plurality of clients comprise human resources clients, said human resources clients enabling human resources personnel to view and/or modify employee specific information.

4. The network of claim 1, where said plurality of clients comprise vendor, said vendor clients enabling vendors to modify information pertaining to an employee benefit provided by said vendor.

5. The network of claim 1, wherein said plurality of databases comprise relational databases.

6. The network of claim 1, where said web server comprises a firewall to prevent unauthorized users from viewing and/or modifying said employee specific information.

7. The network of claim 1, where said employee specific information comprises employee benefits information.

8. The network of claim 1, where said employee specific information comprises job data.

9. The network of claim 1, where said employee specific information comprises employee reporting relationship information.

10. The network of claim 1, where said employee specific information comprises tax withholdings information of an employee.

11. The network of claim 1, where said employee specific information comprises employee paycheck information.

12. The network of claim 1, where said employee specific information comprises previous work experience of an employee.

13. The network of claim 1, where said employee specific information comprises compensation history of an employee.

14. The network of claim 1, where said employee specific information comprises formal education information of an employee.

15. The network of claim 1, where said employee specific information comprises education degree information of an employee.

16. The network of claim 1, where said employee specific information comprises employment related skills information of an employee.

17. The network of claim 1, where said employee specific information comprises employment competencies information of an employee.

18. A method of disseminating employee specific information, said method comprising:
uploading employee specific information into databases of one global computer network from a plurality of employers; and
providing access to said employee specific information through clients accessing secured web servers connected to said databases.

19. The method of claim 18 further comprising providing employees with the ability to view said employee specific information through said clients.

20. The method of claim 18 further comprising providing employees with the ability to modify said employee specific information through said clients.

21. The method of claim 18 further comprising providing human resources personnel with the ability to view said employee specific information through said clients.

22. The method of claim 18 further comprising providing human resources personnel with the ability to modify said employee specific information through said clients.

23. The method of claim 18 further comprising providing vendors of employee benefits with the ability to view information pertaining to a benefit provided by said vendor through said clients.

24. The method of claim 18 further comprising providing vendors of employee benefits with the ability to modify information pertaining to a benefit provided by said vendor through said clients.

25. The method of claim 1 further comprising providing a firewall to secure said employee specific information in said databases.

26. The method of claim 1 further comprising providing the ability for each employee to customize a personalized desktop on a client.

27. The method of claim 1 further comprising connecting said web server to the Internet to provide employees access to the Internet though said clients.
